(19) United States
(12) Patent Application Publication
(10) Pub. No.: US 2022/0132800 A1
(43) Pub. Date: May 5, 2022

(54) Digital Origin Tag and System of Use

(71) Applicant: Ziffereins, Inc., Warren, NJ (US)

(72) Inventor: Thomas Rödding, Münster (DE)

(21) Appl. No.: 17/430,087

(22) PCT Filed: Feb. 19, 2020
(86) PCT No.: PCT/US2020/018737

§ 371 Date: Aug. 11, 2021

(30) Foreign Application Priority Data
Feb. 19, 2019 (DE) 20 2019 100 910.1
Mar. 20, 2019 (DE) 20 2019 101 581.0

(51) Int. Cl. A01K 11/00; A01K 29/00; G06K 19/077; G06K 19/07

(52) U.S. Cl. CPC A01K 11/006; G06K 19/0723; G06K 19/07762; A01K 29/005

(57) ABSTRACT

A system for recording and tracking the processing of an object, such as a killed game animal, or other kind of object. An origin tag has a unique identifier and is attached to the object to be documented and recorded. A database maintains a central registry of the unique identifiers that have been issued on origin tags. The identifiers are disbursed to separate mobile devices, typically smart phones, allowing the user to update information to specific origin tags, without having an Internet connection to the central registry. The data stored on the separate mobile devices are integrated into the central registry, so as to create a complete registry of the unique identifiers, along with the updated information recorded for each of those identifiers

### FIELD OF THE INVENTION

The invention relates to an origin tag that carries a unique identifier and is used to identify an object. More particularly, the invention relates to a system of documenting the unique identifier origin tag to provide traceability of the object through a series of handling steps back to when the origin tag was initially attached to the object.

### DISCUSSION OF THE PRIOR ART

Livestock tags are commonly used in animal husbandry to identify animals and to document the various places or stations the animal has passed through, i.e., to provide information on the animal, traceable back to the when the tag was first installed on the animal. Such traceability is similar to the traceability documented for certain industrial products, showing their procession through various manufacturing and handling steps.

EP 1723847 A1 discloses livestock identification tag that contains various types of information. The tag is equipped with a transponder that contains machine-readable information and has a writable memory, so that the tag includes fixed identification data, as well as data that documents the various places the animal passes through. Alpha-numeric information is provided on the livestock tag that is readable by humans. The tag also includes a piercing tool for taking a tissue sample from the animal, which is then stored in the livestock tag. The tissue sample is typically used for DNA testing or disease testing.

The conditions for collecting data on wild animals or objects found in the wild, however, differ significantly from those for livestock. Livestock are typically easily accessible, because they are on fenced-in pastures or grazing land, or in barns, stalls, milking stands, animal transporters, or slaughterhouses. Wilderness, in this context, is defined as terrain that is not made or adapted by humans. Typically, the terrain is unpaved, vegetation may pose difficulties in traversing the terrain, there are frequently no enclosures or fencing, and the terrain is exposed to the natural elements, i.e., sun, wind, rain, etc. Collecting data on an object or animal in such environments can be challenging. These conditions are not what professionals are used to working in, often making it difficult to record data in the accustomed professional manner.

Filling out a “game animal origin certificate” provides an example of the difficulties when collecting data in the wild. Most jurisdictions require that a wild animal origin certificate be filled out by the hunter when he or she has killed a game animal. This is particularly the case when killing ungulates, i.e., hoofed animals. This wild animal origin certificate is an official paper document, with multiple copies. Information about the hunter, the animal killed, and the game preserve or hunting ground has to be documented. Frequently, additional information is required, such as, the location of the kill within the hunting ground, the time of the kill, the gender of the animal, as well as the estimated weight and age of the animal. Providing precise information on a location in the wilderness is often difficult, because there are few or no landmarks, such as buildings and other man-made structures, roads, etc., that help to precisely identify a location. Also, trying to enter all this information in inclement weather adds complications, which can have a negative effect on the accuracy of the desired documentation.

Aside from hunting situations that require certificates to be filled out on location, there are many other situations that require objects to be located and documented. The forestry industry provides another example of a need to identify an object, such as a tree, and trace its path from its place of origin through to its final destination. Marking, identifying, and locating objects such as trees marked for logging, fallen tree trunks, tools and equipment used in the forest, etc., are all common forestry activities.

What is needed, therefore, is an origin tag that provides a unique identifier for an object or animal to be documented. What is further needed is a system for collecting information from the origin tag and providing traceability of the stations the object or animal passes through. What is yet further needed is such a system that is usable even when continuous connection to a communications network is not available.

### BRIEF SUMMARY OF THE INVENTION

It is an object of the invention to generate an origin tag that is easy to handle, even under unpleasant weather conditions, and to provide a data system that integrates the information on the origin tag into a greater data infrastructure, so as to provide consumer-oriented traceability of the object that carried the origin tag, from its final destination back through the various processing steps to the initial attachment of the origin tag.

The data system according to the invention includes a central registry and a data device, such as a smart phone. The registry preferably provides access to multiple, structured layers of information and defines differentiated access authorizations in order to control and restrict access to data that is stored in the central registry.

The origin tag according to the invention is a digital origin tag with a unique identifier that is provided in multiple representations on the tag. There are several ways of generating the unique identifier: A Unique Universal Identifier (UUID)/Global Unique Identifier (GUID) can be generated by the Internet Engineering Task Force (IETF) by submitting a Specification Request for Comments (RFC) according to IETF RFC 4122. This type of unique identifier typically has 32 characters, although the identifier can be abbreviated to 20 characters by using hash algorithms or extended to 40 characters as a number in the decimal system. Regardless of the type of representation that is selected, acquiring the unique identifier in this way allows a unique identifier to be generated, without a central issuing agency and without connection to the Internet, at any time and at any location, so that even individual technical devices are able to determine this unique identifier without connection to a network.

As far as probability is concerned, the issuance of the digital origin tag according to the method described below precludes the issuance of duplicate identifiers and the system ensures the property of traceability of unique objects. In order to demonstrate to the authorities that all origin tags have been completely recorded, proof of the uniqueness of the issued UUlDs is adequately documented, when each digital origin tag, along with its unique identifier, is registered in a central registry.

Regulatory authorities may require a consecutive numbering of the unique identifier origin tags for legal traceability. In that case, the unique identifier numbers are maintained in a central registry. The numbers are issued consecutively, synchronized and sequentially, so that it is impossible to issue the same number twice. The numbers are preferably issued to users in batches, and those issued batches are then maintained on separate storage devices at the places of use, for example, are stored on smart phones. From the perspective of the central system, then, a consecutive series of numbers has been issued as a batch to device X. Having a batch of unique identifiers on the user's smart phone allows the user to assign the numbers from this batch as needed to origin tags, to provide unique identification tags for objects, without the user's device needing a network connection to the central registry in order to obtain an identifier. When, at a later time, a connection to the central registry is available, the user then reports back to the central registry the details of how the numbers in a particular series were used. Traceable, consecutive numberings without gaps are eventually created in the central registry, when the consecutive batches of numbers that were disbursed by the central registry and which, in the meantime, have been stored and used in decentralized user devices, have been used up and reported back to the registry.

It can be advantageous to use the UUID method referenced above to acquire a unique identifier for the digital origin tag, because it does not involve any of the effort of managing a consecutive numbering. The necessary documentation is then provided when the identifier is subsequently registered in the central registry.

The digital origin tag with its unique identifier is a unique item and the unique identifier is contained on the digital origin tag in three different representations:
Optically readable for humans. The unique identifier is displayed as a 32-character alpha-numeric code that is a hexadecimal representation of a number.
Optically machine-readable. The unique identifier is displayed as a matrix or two-dimensional barcode, such as a QR code that contains within its matrix an Internet URL, which, in turn, contains the unique identifier.
Non-optically machine-readable. The unique identifier is provided on a chip and is wirelessly transmitted to a scanner or reader device, for example, by induction or radio transmission. This type of readability requires no external electrical contacts, so that the specific data carrier may be stored within the origin tag, optimally protected against external elements. The data carrier may be constructed as transponder and transmitter, for example, as an RFID chip or NFC chip with the unique identifier stored in its memory.

It may be advantageous to integrate the implementation of this technical invention into existing methods, for example, ISO/IEC 16022, ISO/IEC 18004:2006, ISO/IEC 14443, ISO/IEC 15693, ISO/IEC 13157, 16353, 22536, 28361.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a perspective view of a digital origin tag according to the invention, which, in this embodiment, serves as a digital game tag to identify a killed game animal.

### DETAILED DESCRIPTION OF THE INVENTION

The present invention will now be described more fully in detail with reference to the accompanying drawing, in which one embodiment of the invention is shown. This invention should not, however, be construed as limited to the embodiment set forth herein; rather, it is provided so that this disclosure will be complete and will fully convey the scope of the invention to those skilled in the art.

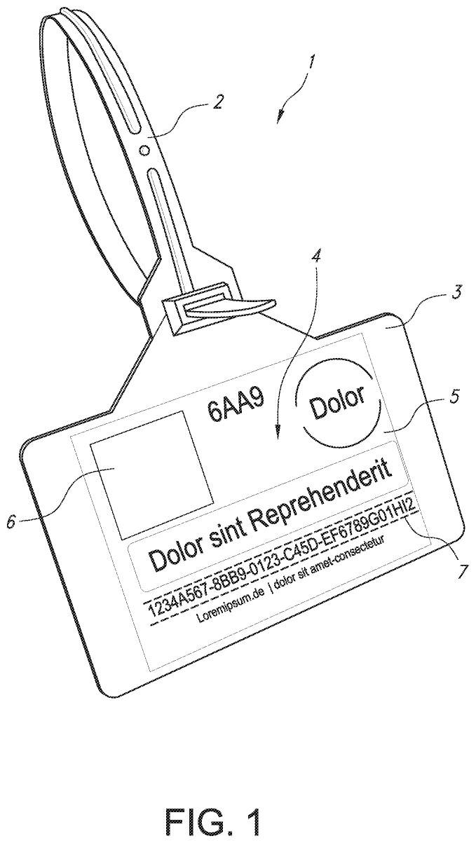

FIG. 1 illustrates a digital origin tag 1 according to the invention, which, solely for purposes of providing a complete description, is a digital game tag used to identify a game animal that has been killed. The digital origin tag 1 is a unitary molded plastic component comprising an identifier plate 3 and an attachment loop 2. The attachment loop 2 is similar to a cable tie and is used to quickly and easily attach the digital origin tag 1 to the animal. Preferably, in its use as a game tag, the attachment loop 2 is designed to be unreleasable once attached, i.e., it can be closed just once and can be opened only by destroying it, thereby preventing the tag 1 from being used a second time to identify another game animal or object. Depending on the particular intended use of the digital origin tag 1, however, it is understood that the loop 2 may also be designed as a re-openable closure.

The digital origin tag 1 has been given a unique identifier, preferably a world-wide one-of-a-kind identification, by the manufacturer when it was produced and the identifier plate 3 contains three different expressions or representations of that unique identifier, the first one being a machine-readable code that is programmed into a machine-readable chip 4. The chip 4 is a radio-wave readable chip that is embedded into the plastic material of the identifier plate 3 and is not visible on the outside of the digital origin tag 1. The manufacturer assigned the unique identifier to the chip 4 during production and only an arrow in a drawing indicates the location of the chip 4. Alternatively, it is possible to adhesively affix the chip 4 or a housing in which the chip 4 is stored to the identifier plate 3 or to affix it in some other way. Suitable scanner or reader devices are used to read the chip 4.

The chip 4 in the illustrated embodiment also has a writable memory, allowing the user, in this case, the hunter, to store additional information in the chip 4. Examples of such additional information include location of the animal kill, time of the kill, information about the species, gender, and estimated age and weight of the wild animal, as well as information relating to the identity of the hunter. Depending on the memory capacity of the chip 4, images may also be stored. For example, it may be desirable to document particular characteristics of the animal with a digital photo.

In the embodiment shown, the machine-readable chip 4 is constructed as an NFC (Near Field Communication) chip, so that it is readable with commercially available mobile phones. Mobile phones also make it possible to generate the mentioned additional information in alpha-numeric form via the physical or virtual keyboard on the phone and/or or as a digital photo with the aid of phone camera. Furthermore, mobile phones, particularly smart phones, readily provide the opportunity to run a program, i.e., an app, that communicates with the chip 4 and is able to either read out data from the chip 4 or to store data in the writable storage area of the chip 4. Due to the short-distance range of the NFC radio standard, inadvertent communication between the specific device being used and an digital origin tag other than the targeted digital origin tag 1 is practically impossible.

The other two representations of the same unique identifier that is on the NFC-chip 4 are provided on a label 5 that is adhesively affixed to the identifier plate 3 and are optically readable, one by humans and one by a scanner. A machine-readable two-dimensional barcode, in this case, a QR code, is displayed in the symbol field 6. This QR code is readable by a special scanning device or the code may be first captured by the camera in a mobile phone and then read by means of a suitable app that runs on the mobile phone and that then displays the unique identifier on the mobile phone screen. The third representation of the identification code provided on the digital origin tag 1 is an alpha-numeric code displayed in the text field 7, in plain writing that is readable for humans.

In this embodiment, the user may also write the information by hand in the label 3. Rather than affixing the label 5 to the identifier plate 3, it is possible that the information provided on the label be written directly onto the identifier plate 3. In this case, a particular area of the identifier plate 3 may be specifically constructed to be written on, for example, by providing a certain surface roughness, so that the user can write on it, using a suitable instrument, such as a grease pen, ballpoint pen, felt-tip pen, etc.

The system according to the invention includes a central registry and integration of the data from the digital origin tag 1 into the central registry. As mentioned, the digital origin tag 1 is described herein as a digital game tag. It is foreseeable that the killed animal will be processed through multiple stations on its way to becoming game meat that is offered for sale to an end-consumer. Consumers may want to know where the meat came from and how it was processed. The system according to the invention provides that desired traceability by documenting the path that the animal has taken from the time it was killed and the digital origin tag 1 was attached to it, until a piece of meat from it appeared on a store shelf as food.

This digital game tag 1 is registered after it has been produced and before it is entered into the central game tag registry. The central game tag registry is in the form of a database that runs on a computer; the database has a plurality of data fields that accommodate the information that has been agreed upon as being required to be submitted to this central registry. For every digital origin tag, i.e., for every digital game tag, the registry has a data field that is referred to as the identifier field and that contains the identification code for the individual game tag. Additional data fields may be provided in the registry for information that has been defined as accessible to the public. This may be information about the manufacturer and/or the agency that issued the game tag, perhaps also information about the hunter, the time of the kill, the location of the kill, and information on the specific animal.

In a first embodiment, this central registry has a section that is open to the public, i.e., a public section with unrestricted access, which contains the above-mentioned information or data fields. Laws or regulations relating to data protection may, however, require making some information anonymous. In this embodiment, anyone can read the information in the data fields in this public section, but preferably data may be entered into these data fields only after showing proof of proper authorization.

The central registry may also have a private section that contains data fields that are under restricted access, i.e., which can be looked at only upon entering the required access authorization. The personal data of the individual hunter is an example of such private data. This private section may be accessed by the specific end user, i.e., by that person or enterprise who currently owns or is processing the particular game animal or meat product from the animal—and thus, currently owns the game tag, for example, the hunter who'd killed the game, and then later a meat-processing plant, or then after that, a place of business that sells or distributes the game meat to the final customer.

It is also possible, to restrict access to this private section to the manufacturer or issuing agency for the game tags and to provide a separate, but related database that is synchronized with the central registry and that is maintained by the manufacturer or the tag issuing agency. Certain data fields in this separate database may be automatically synchronized with the central registry. But also, the manufacturer or agency database may have additional data fields that are not synchronized with the central registry, and contain information on additional services that the manufacturer or the issuing agency offers to the buyer or user of the applicable game tag, or to third parties.

As an alternative to storing public and private data fields in the same database, namely in the central game tag registry, different data fields for the same game tag may be maintained in a public, central game tag registry, as well as in a private registry, which is maintained, for example, by the manufacturer of the particular game tag. For example, the manufacturer or the game tag issuing agency may exclusively maintain private data fields, with a link between the central registry and the corresponding private registry, so that, after calling up the game tag and entering the corresponding access code or authorization, properly authorized persons also gain access to the additional entries that are stored in this private registry, and with this access, are able to enter and store additional information in that private registry.

Technical interfaces that allow bi-directional synchronization of pending data then allow a cooperation between the game tag registry and different manufacturer-owned systems. The interface model between the central registry and manufacturer-owned systems is conceivably similar to the Corporations Register in state governments or county court systems. With that kind of register, information relating to corporations that the state deems reportable is provided in the Corporate Register. Nevertheless, business information with credit information remains restricted to the various companies (manufacturers), who have to prove their need to access such information by providing the necessary authorization.

The system according to the invention is based on a model that is similar to the Corporate Register system, in that the central registry allows bi-directional synchronization via modern application programming interfaces (for example, REST/GraphQL) and allows selectively controlled processing of data in accordance with modern security aspects (OAuth & other authenticators). Continuing with the example of a digital game tag, the manufacturer-owned systems may store additional data from their own business models (for example, a photograph of the hunter), whereas the central registry is restricted to data that is required to be submitted to the central registry. (cf. “Tierische Lebensmittel-Hygieneverordnung (Animal Food Hygiene Regulation), Publication date 18 Apr. 2018, Bundesgesetzblatt I, (Federal Gazette I), page 480 (619)”, Annex 8a. Aspects of the digital signature and/or advanced or qualified digital signature according to EU-Law (for example, EU-Regulation 910/2014) can be incorporated as central components.

Thus, it may be advantageous to implement the central game tag registry such, that, in an open market, the various manufacturers who comply with the standards that are specified by the game tag registry are allowed to register their own digital origin tags as unique tags in the central game tag registry, and then describe added-value services in their own systems, which are bi-directionally synchronized with the central game tag registry.

The actual implementation of this invention could be as follows, as applied to a hunter killing an animal and using the digital origin tag as a digital game tag:

A manufacturer DWM produces game tags as unique objects, each having a unique universal identifier (UUID), the UUIDs registered with the central game tag registry via interfaces before the tags are acquired by hunters through conventional distribution channels. As soon as a hunter has killed an animal, in Europe typically an ungulate, and exercises his ownership right, he identifies the individual animal using the digital game tag from DMW as the game origin identifier. Using his smart phone, he reads the registered UUID code via the QR code, but if dirt is making the QR code unscannable, he reads the code on the NFC chip. The app installed on the smart phone reports the required data that is in conformity with central game tag registry, for example, identity of the person authorized to hunt, GPS coordinates of the place of the kill, species of kill. Additional information intended for the manufacturer-owned IT system may be recorded at the same time. The user then adds additional information, after retrieving and doing the initial processing of the killed animal, for example, estimated age and game weight, and the hunter declaration acc. to regulations that govern game animals and which are later processed as food. This information is then stored partially in central game tag registry and partially in the manufacturer-owned IT system.

The central game tag registry allows additional game tags, each with its unique identifiers, to be “appended” to the original digital origin tag. Sample bags that hold tissue samples and swabs that will be sent off for official laboratory testing are identified with the unique identifiers, preferably the same type as the unique identifier of the original digital origin tag, i.e., a UUID with a two-dimensional barcode and NFC chip in the tag), which are then allocated to the original digital game tag via a smart phone app. Similarly, additional game tags may be used in later processing of the game animal, to identify pieces of meat as derived from the animal with the original digital origin tag. This provides tamper-proof traceability of the laboratory samples and/or food and allows allows each object with an appended tag to be matched up in the game tag registry with the data of the animal. These appended digital origin tags may also, as needed, be properly allocated to the original digital origin tag in the manufacturer-owned IT system, along with any value added services relating to objects identified with these appended tags.

The same applies for documents being generated in the further course of processing that are matched up with the official test reports, which are then matched to the samples and, thus, to the origin of the killed game animal via the unique identifier by means of the two-dimensional barcode based on the UUID.

Use and documentation of the digital unique origin identifier continues, as necessary, in the primary production of food, where the examined piece of game is finally packed in kitchen-ready, consumer packaging, whereby the packaging is identified with the origin identifiers showing the UUID in QR code and/or with the NFC tag. It is possible for the consumer of each package to look into the central game tag registry and to identify precisely each individual package via the process of matching the digital origin tag, so that there is precise documentation for every individual package of food produced from the killed animal, for example, a package of wild boar ham, with traceability back to when the digital origin tag was initially placed on the animal. This traceability goes far beyond the European requirements for hygiene in dealing with foodstuffs, according to Annex II, Section III, Number 3 of the Regulation (EG) No. 853/2004.

Another desirable application of the digital origin tag according to the invention is in the field of forestry. In this case, the plastic used for the digital origin tag may be made more resistant to impact and weather. Given the likelihood that the digital origin tag in this application will regularly be exposed to the elements of weather, the information that is provided on the label is preferably printed or imprinted directly into the plastic, to avoid losing information that has been rubbed off or made illegible due to rain.

The digital origin tag, now used as a tree tag, allows the location of a tree and the time of its felling to be documented. The location data may be determined at the location of the tree site, either while the tree is still standing or has just been felled, or at a logging landing/staging area. In the former case, the location data is accurate to the precise meter of the actual tree site; in the latter case, the location data is at least accurate with regard to the general area. Having precise location data for a tree trunk may be commercially important. For example, due to different climate conditions, such as sunlight and wind, the wood from trees can differ depending on their locations. Trees grown in the same valley, but on opposite slopes can have different properties that influence the technical performance of the wood, for example, the particular location where the tree grew may have a significant effect on the acoustics of an instrument built from the wood, or on the mechanical strength of wood that is intended for use construction.

Dual antennas may be provided in the specific transponder and transmitter chips that are used in the digital origin tag, so that the same chip operates with different frequencies and is readable in close range by a smart phone that reads the NFC frequency, but also readable in the UHF range RFID readers. This second antenna increases the distance over which communication with the chip is possible by several meters, thereby allowing the chip to be read from a vehicle. Conventional active transmitters, such as, for example, in the area of the iBeacon (see https://en.wikipedia.org/wiki/Types_of_beacon) are also able to bridge greater distances between the reader and the digital origin tag.

Drones may be fitted with devices to scan or read the chip in the digital origin tag. This allows large-area scanning for locations or objects that have been identified by digital origin tags, for example, harvested tree trunks in the forest. The signal strength in connection with the drone's own GPS data allows the recognized locations/objects to be documented in a fly-over, even without a direct line of sight.

The digital origin tag may also be used solely as a unique identifier, without the traceability function. Thus, the location or position of an object identified with the digital origin tag may be recorded automatically with radio support. Accordingly, such an identifier may be used not only for identifying killed game animals or harvested wood, but also to identify mobile objects that carry such tags. Fly-over with a drone equipped with a radio device allows the mobile objects to be automatically located, recorded, and mapped. Such use is useful in agriculture and forestry, for locating mobile equipment, and also for locating mobile hunting stands. It is even possible to map certain areas, for example, hunting grounds or certain sections of the grounds, by marking the corresponding areas with such digital origin tags.

It is understood that the embodiments described herein are merely illustrative of the present invention. Variations in the construction of the digital origin tag and the system of use for the digital origin tag may be contemplated by one skilled in the art without limiting the intended scope of the invention herein disclosed and as defined by the following claims.

What is claimed is:

1: A digital origin tag having a unique identifier, the digital origin tag comprising:
an identifier plate and an attachment element for attaching the digital origin tag to an object to be identified;
a chip that contains a non-optical, machine-readable code, the chip being unremovably assembled on the identifier plate;
a machine-readable optical code that is visible in a first symbol field on the identifier plate; and
an alpha-numeric code that is visible in a second symbol field on the identifier plate.

2: The digital origin tag of claim 1,
wherein the non-optical, machine-readable code, the optical machine-readable code, and the alpha-numeric code are three different representations of the unique identifier.

3: The digital origin tag of claim 1,
wherein the unique identifier is generated as a UUID (Unique Universal Identifier).

4: The digital origin tag of claim 1,
wherein the unique identifier is generated as a GUID (Global Unique Identifier).

5: The digital origin tag of claim 3,
wherein the UUID is represented in a code of 32 characters.

6: The digital origin tag of claim 3,
wherein the code is represented in a 40-digit number in the decimal system.

7: The digital origin tag of claim 1, wherein the identifier plate and attachment loop are embodied in a unitary molded plastic component.

8: The digital origin tag of claim 7, wherein the chip is embedded in the molded plastic of the identifier plate.

9: The digital origin tag of claim 1, where the chip is an NFC-chip.

10: A system for recording and tracking an object through a plurality of handling steps, the system comprising:
a digital origin tag having a unique identifier, the digital origin tag being attached to the object to be recorded and tracked;
a database that runs on a PC and serves as a central registry for a plurality of digital origin tags;
multiple data fields provided in the registry for each of the plurality of digital origin tags;
wherein an identifier field is assigned to each digital origin tag, the identifier field containing the unique identifier of the digital origin tag, as well as at least one additional data field.

11: The system of claim 9, further comprising:
a plurality of data fields writable by the user of the digital origin tag;
wherein the user enters data on various handling steps the object passes through, thereby providing traceability information about the object, back to when the digital origin tag was initially attached to the object.

12: The system according to claim 10,
wherein the plurality of data fields includes public data fields that are accessible to the public and private data fields that are readable and/or writable only by means of an access authorization.

13: The system of claim 9, further comprising:
a private database having a plurality of private data fields for each of the plurality of digital origin tags;
wherein, of the plurality of data fields for each digital origin tag, a data field is designed as the identifier field, which contains the unique identifier of the digital origin tag, as well as at least one additional data field, which is readable and/or writable only with appropriate access authorization.
